(19) United States
(12) Patent Application Publication
(10) Pub. No.: US 2025/0100311 A1
(43) Pub. Date: Mar. 27, 2025

(54) TRANSPORT DEVICE AND RECORDING DEVICE

(71) Applicant: SEIKO EPSON CORPORATION, Tokyo (JP)

(72) Inventor: Shin KOMATSU, SHIOJIRI-SHI (JP)

(21) Appl. No.: 18/896,708

(22) Filed: Sep. 25, 2024

(30) Foreign Application Priority Data
Sep. 27, 2023 (JP) 2023-165978

(51) Int. Cl. B41J 29/17; B41J 15/04

(52) U.S. Cl. CPC B41J 29/17; B41J 15/048

(57) ABSTRACT

A transport device 1 includes a transport belt 5 that includes an outer peripheral surface 5a for supporting a medium M and that is configured to transport the medium M; a blade 93 configured to wipe the outer peripheral surface 5a by contacting the outer peripheral surface 5a; a first frame 91 that holds the blade 93; an elastic member 95 configured to bias the first frame 91 in a direction in which the blade 93 contacts the outer peripheral surface 5a; and a second frame 92 that supports the first frame 91 so that the first frame 91 is movable along a normal direction of the outer peripheral surface 5a.

The present application is based on, and claims priority from JP Application Serial Number 2023-165978, filed Sep. 27, 2023, the disclosure of which is hereby incorporated by reference herein in its entirety.

### BACKGROUND

### 1. Technical Field

The present disclosure relates to a transport device and a recording device.

### 2. Related Art

In the related art, various transport devices have been used. Among these, there is a transport device that includes a transport belt that transports a medium while supporting the medium on an outer peripheral surface, and a blade that can wipe the outer peripheral surface. For example, JP-A-2014-47034 discloses an inkjet recording device that includes a transport belt that transports a medium while supporting the medium on an outer peripheral surface of the transport belt, and a secondary wiping blade that is capable of wiping the outer peripheral surface of the transport belt while contacting a front surface of the transport belt.

The inkjet recording device of JP-A-2014-47034 further includes a secondary fixing plate to which a secondary wiping blade is fixed by screws, a secondary pressing member for pressing a base end section of the secondary wiping blade against the secondary fixing plate, and a plurality of secondary fixing screws for fastening the secondary pressing member to the secondary fixing plate. In the device including such a configuration, reaction force to the transport belt depends only on elasticity of the blade. That is, the degree of freedom between the transport belt and the blade corresponding to reaction force to the transport belt required for the device is narrow. As described above, in the related art transport device in which the degree of freedom between the transport belt and the blade is narrow, ease of assembly at the time of assembling the device, such as attachment of the transport belt, tends to be reduced.

### SUMMARY

The transport device of the present disclosure for overcoming the above-described problem includes a transport belt that includes an outer peripheral surface for supporting a medium and that is configured to transport the medium; a blade configured to wipe the outer peripheral surface by contacting the outer peripheral surface; a first frame that holds the blade; an elastic member configured to bias the first frame in a direction in which the blade contacts the outer peripheral surface; and a second frame that supports the first frame so that the first frame is movable along a normal direction of the outer peripheral surface.

### BRIEF DESCRIPTION OF THE DRAWINGS

FIG. 1 is a schematic side view of a recording device according to a first embodiment of the present disclosure.

FIG. 2 is a perspective view showing a blade forming section of the recording device of FIG. 1.

FIG. 3 is a partially enlarged view of FIG. 2.

FIG. 4 is a perspective view showing the blade forming section of the recording device of FIG. 1, as viewed from an angle different from that of FIG. 2.

FIG. 5 is a perspective view showing a periphery of a first frame of the blade forming section of the recording device of FIG. 1.

FIG. 6 is a rear view showing a periphery of the first frame of the blade forming section of the recording device of FIG. 1.

FIG. 7 is a side cross-sectional view showing a periphery of the first frame of the blade forming section of the recording device of FIG. 1.

FIG. 8 is a graph showing a relationship between an overlap length and a biasing force with respect to an outer peripheral surface of a blade of the recording device of FIG. 1.

FIG. 9 is a side cross-sectional view showing a periphery of a first frame of a blade forming section of a recording device of a reference example.

FIG. 10 is a graph showing a relationship between an overlap length and a biasing force with respect to an outer peripheral surface of a blade of the recording device of the reference example.

FIG. 11 is a side cross-sectional view showing a periphery of a first frame of a blade forming section of a recording device according to a second embodiment of the present disclosure.

### DESCRIPTION OF EMBODIMENTS

First, the present disclosure will be schematically described.

A transport device according to a first aspect of the present disclosure for overcoming the above-described problem includes a transport belt that includes an outer peripheral surface for supporting a medium and that is configured to transport the medium; a blade configured to wipe the outer peripheral surface by contacting the outer peripheral surface; a first frame that holds the blade; an elastic member configured to bias the first frame in a direction in which the blade contacts the outer peripheral surface; and a second frame that supports the first frame so that the first frame is movable along a normal direction of the outer peripheral surface.

According to the present aspect, the transport device includes a first frame that holds the blade; an elastic member configured to bias the first frame in a direction in which the blade contacts the outer peripheral surface; and a second frame that supports the first frame so that the first frame is movable along a normal direction of the outer peripheral surface. Since the elastic member is provided, the degree of freedom between the transport belt and the blade can be increased, and since the second frame movably supports the first frame along the normal direction of the outer peripheral surface, the distance between the transport belt and the blade can be particularly increased. Therefore, ease of assembly of the device can be improved.

A transport device according to a second aspect of the present disclosure is an aspect according to the first aspect, and the elastic member is a spring.

According to the present aspect, the elastic member is a spring. With such a configuration, the elastic member can include a simple configuration at low cost.

A transport device according to a third aspect of the present disclosure is an aspect according to the second aspect, and the spring includes an attaching section configured to be attached to the first frame and the second frame.

According to the present aspect, the spring includes an attaching section configured to be attached to the first frame and the second frame. With such a configuration, the elastic member can be attached to the first frame and the second frame, and the second frame that movably supports the first frame along the normal direction of the outer peripheral surface can be easily configured.

A transport device according to a fourth aspect of the present disclosure is an aspect according to the first aspect, and the elastic member is attached to the first frame and the second frame and is configured to be attached to and detached from the first frame and the second frame.

According to the present aspect, the elastic member is attached to the first frame and the second frame and configured to be attached and detached with respect to the first frame and the second frame. With such a configuration, the elastic member can be easily attached to the first frame and the second frame, and ease of assembly of the device can be particularly improved.

A transport device according to a fifth aspect of the present disclosure is an aspect according to the fourth aspect, and the first frame is configured to attach a plurality of the elastic members.

According to the present aspect, the first frame is configured to attach a plurality of the elastic members. With such a configuration, for example, by changing the number or type of elastic members attached to each first frame, it is possible to bias the blade against the outer peripheral surface with an appropriate biasing force.

A transport device according to a sixth aspect of the present disclosure is an aspect according to the fifth aspect, and a plurality of the first frames are connected to one second frame via the elastic member.

According to the present aspect, a plurality of the first frames are connected to one second frame via the elastic member. With such a configuration, it is easy for the second frame to support each of the first frames so as to be movable along the normal direction of the outer peripheral surface, and it is possible to improve the followability of the first frame with respect to the outer peripheral surface. Therefore, effect of the blade wiping the outer peripheral surface can be enhanced.

A transport device according to a seventh aspect of the present disclosure is an aspect according to the first aspect, and the transport device includes a sliding member positioned between the first frame and the second frame.

According to the present aspect, the transport device includes a sliding member between the first frame and the second frame. Therefore, the first frame is easily moved with respect to the second frame.

A recording device according to an eighth aspect of the present disclosure includes the transport device according to any one of the first to seventh aspects and a recording section configured to perform recording on the medium transported by the transport belt.

According to the present aspect, recording is performed on the medium transported by the transport section of the above-described transport device. For this reason, it is possible to perform recording on the medium using the recording device with improved ease of assembly.

### First Embodiment

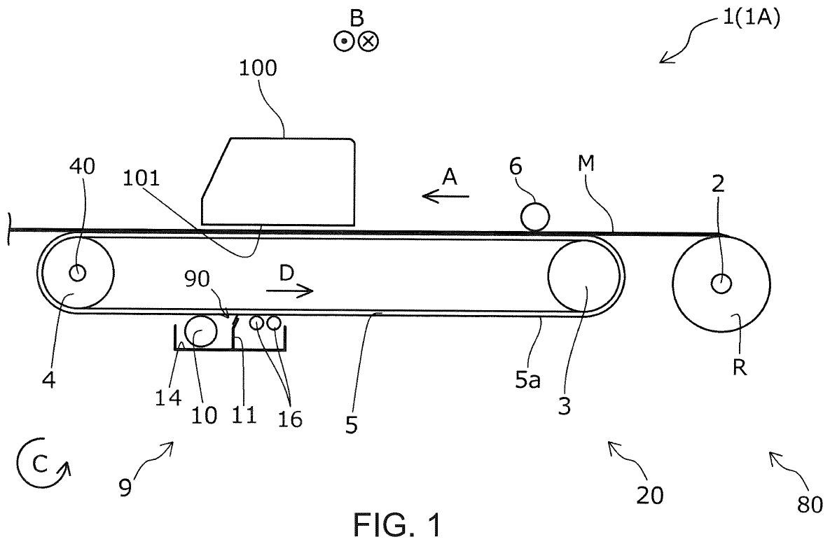

Hereinafter, embodiments of the present disclosure will be described with reference to the accompanying drawings. First, the outline of a recording device 1A according to a first embodiment, which is a transport device 1 and a recording device 1 of the present disclosure, will be described with reference to FIG. 1.

As shown in FIG. 1, the recording device 1A of the present embodiment includes a holding section 80 which can rotatably hold a roll body R in which a medium M is wound in a roll shape, and a transport section 20 that includes a drive section 40, which is a motor, and that transports the medium M which is fed from the holding section 80 in a transport direction A by driving force of the drive section 40.

The holding section 80 includes a holding shaft 2 that holds the roll body R to be passed through a paper tube constituting a rotation shaft of the roll body R. The holding section 80 can rotate the holding shaft 2 in a rotation direction C to feed the medium M from the roll body R to the transport section 20. The recording device 1A of the present embodiment includes a pressure roller 6 that presses the medium M against the transport belt 5 in a region that faces a transport belt 5, which configures the transport section 20. However, the pressure roller 6 and the like may not be provided.

The transport section 20 includes a driven roller 3, which is positioned on an upstream side of the transport direction A, a drive roller 4, which is positioned on a downstream side of the transport direction A, and the transport belt 5, which is an endless belt wound around the driven roller 3 and the drive roller 4. Here, the transport belt 5 is an adhesive belt including an outer peripheral surface 5a in which an adhesive is applied to a support surface of the medium M which is an outer surface.

As shown in FIG. 1, the medium M is transported by being supported by the transport belt 5 in a state in which the medium M is adhered to the outer peripheral surface 5a. In the recording device 1A of the present embodiment, a medium support region of the transport belt 5 that supports the medium M is an upper region spanning between the driven roller 3 and the drive roller 4. The drive roller 4 is a roller rotated in the rotation direction C by a driving force of the drive section 40, which is a motor, and the driven roller 3 is a roller rotated by being driven by the rotation of the transport belt 5 according to the rotation of drive roller 4.

The recording device 1A of the present embodiment includes a carriage 100 which can reciprocate in a width direction B of the transport belt 5, and a head 101 which is attached to the carriage 100. The head 101 is a recording section capable of recording an image by ejecting liquid ink onto the medium M transported in the transport direction A based on record data.

The recording device 1A of the present embodiment can form an image by ejecting ink from the head 101 onto the transported medium M while reciprocating the carriage 100 in the width direction B intersecting the transport direction A. By providing the carriage 100 with such a configuration, the recording device 1A of the present embodiment can form a desired image on the medium M by repeating transport of the medium M in the transport direction A by a predetermined transport amount and ejection of ink while moving the carriage 100 in the width direction B in a state where the medium M is stopped.

As described above, the recording device 1A of the present embodiment includes an ejection head of a so-called serial head type in which the head 101 mounted on the carriage 100 reciprocates in the width direction B. However, the present disclosure is not limited to such an ejection head. For example, the present disclosure may be a line head type recording section in which the head 101 extends in the width direction B and is fixed, and a plurality of nozzles that eject ink along the width direction B are arranged. In a case of the configuration including the line head type recording section, the medium M can be transported by so-called continuous transport in which the medium M is continuously transported, instead of transporting the medium M by so-called intermittent transport in which transport of the medium M by a predetermined transport amount and stoppage of the medium M are repeated as in the recording device 1A of the present embodiment.

When the medium M on which an image is formed by ejecting ink from the head 101 is discharged from the recording device 1A of the present embodiment, the medium M is sent to a drying device for volatilizing components of ink ejected onto the medium M or a winding device for winding up the medium M on which an image is formed, which is provided at a later stage than the recording device 1A of the present embodiment.

Here, as the medium M, a printing material can be desirably used. Printing material refers to fabric, garments, other clothing products, and the like that are the target of printing. A fabric includes woven, knitted, and nonwoven fabrics made of natural fibers such as cotton, silk, and wool, chemical fibers such as nylon, or composite fibers mixed with these fibers. Garments and other clothing products include sewn T-shirts, handkerchiefs, scarves, towels, carrier bags, bags made of cloth, curtains, sheets, bedspreads, and other furniture, as well as fabric before and after cutting, which exists as parts before being sewn together. However, in addition to the above-described printing material, dedicated paper for inkjet recording, such as plain paper, high-quality paper, and glossy paper, can also be used.

In a case where a printing material is used as the medium M, since the printing material is likely to cause strike-through of ink, which is a phenomenon in which ink ejected onto the medium M bleeds to the surface of the rear side, the transport belt 5 may be contaminated with the ink. Therefore, the recording device 1A of the present embodiment includes a washing section 9 for cleaning the ink which is deposited to the transport belt 5 by the strike-through. The washing section 9 of the present embodiment includes a blade forming section 90 that will be described later in detail, a storage tank 14 in which washing liquid is stored, a washing roller 10 that is immersed in the washing liquid and that contacts the transport belt 5, a blade 11 that extends in the width direction B and that wipes the washing liquid clinging to the transport belt 5, and absorbent rollers 16 that absorb the washing liquid that was not wiped by the blade 11. A direction in which the transport belt 5 rotates when the recording device 1A of the present embodiment transports the medium M in the transport direction A is the rotation direction C, and the direction in which the transport belt 5 moves with respect to the blade forming section 90 at that time is a movement direction D.

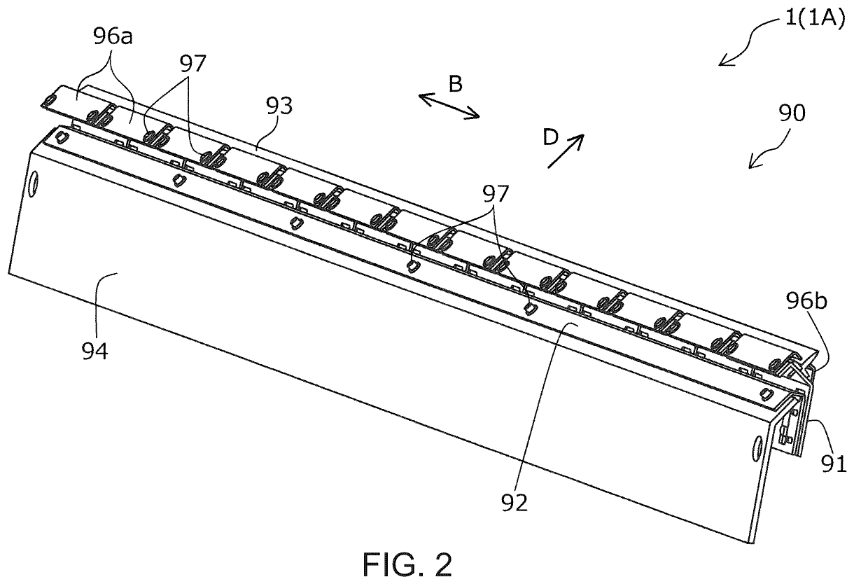

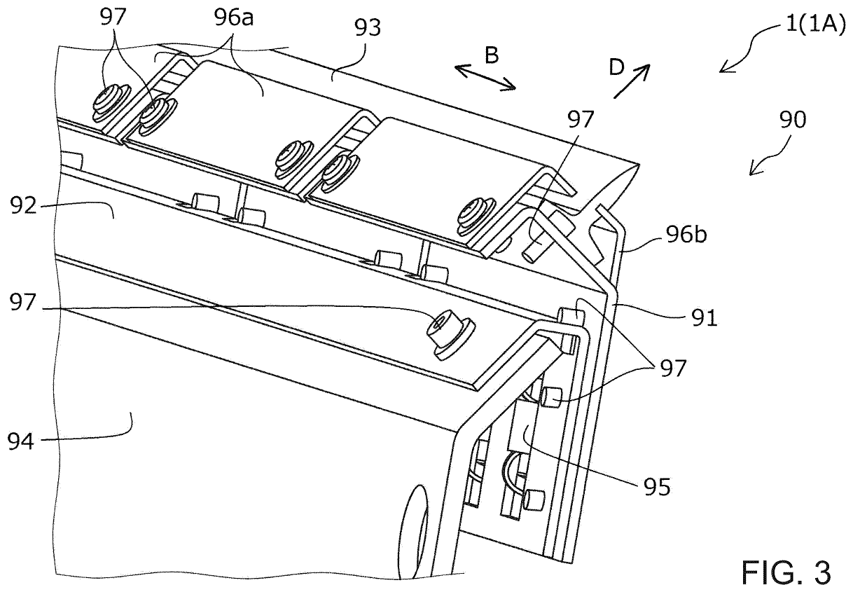

Next, the blade forming section 90 of the washing section 9, which is a main part of the recording device 1A of the present embodiment, will be described in detail with reference to FIGS. 2 to 10. As described above, the recording device 1A of the present embodiment includes the transport belt 5 including the outer peripheral surface 5a for supporting the medium M and capable of transporting the medium M, and the blade 11 capable of wiping the outer peripheral surface 5a by contacting the outer peripheral surface 5a. As shown in FIGS. 2 to 7, the recording device 1A of the present embodiment includes, as the blade forming section 90, a first frame 91 including metal plates 96a and 96b and holding a blade 93 by the metal plates 96a and 96b in addition to the blade 93, a metal plate 94 extending in the width direction B, and a second frame 92 fixed to the metal plate 94 by a plurality of screws 97 and extending in the width direction B.

Here, the second frame 92 movably supports the first frame 91 along a vertical direction corresponding to a normal direction of the outer peripheral surface 5a. The recording device 1A of the present embodiment includes, as the blade forming section 90, a spring 95, which is an elastic member connected to the first frame 91 and the second frame 92 and that biases the first frame 91 with respect to the second frame 92 in a vertically upward direction, which is a direction in which the blade 93 contacts the outer peripheral surface 5a.

As described above, the recording device 1A of the present embodiment includes the first frame 91, which holds the blade 93, the spring 95 as an elastic member that biases the first frame 91 in a direction in which the blade 93 contacts the outer peripheral surface 5a, and the second frame 92, which movably supports the first frame 91 along the normal direction of the outer peripheral surface 5a. In the recording device 1A according to the present embodiment, since the elastic member is provided as described above, it is possible to broaden the degree of freedom between the transport belt 5 and the blade 93. The recording device 1A of the present embodiment includes a configuration in which the second frame 92 movably supports the first frame 91 along the normal direction of the outer peripheral surface 5a, making it possible to particularly increase the degree of freedom between the transport belt 5 and the blade 93. Therefore, the recording device 1A of the present embodiment has improved ease of assembly. In the recording device 1A of the present embodiment, the second frame 92 is configured to movably support the first frame 91 along the normal direction of the outer peripheral surface 5a, so that force of the blade 93 can be efficiently applied to transport belt 5.

As described above, the recording device 1A of the present embodiment includes the head 101 as the recording section capable of performing recording onto the medium M transported by the transport belt 5. That is, recording is performed on the medium M transported by the transport belt 5. For this reason, the recording device 1A of the present embodiment can perform recording onto the medium M in the recording device 1 in which ease of assembly is improved.

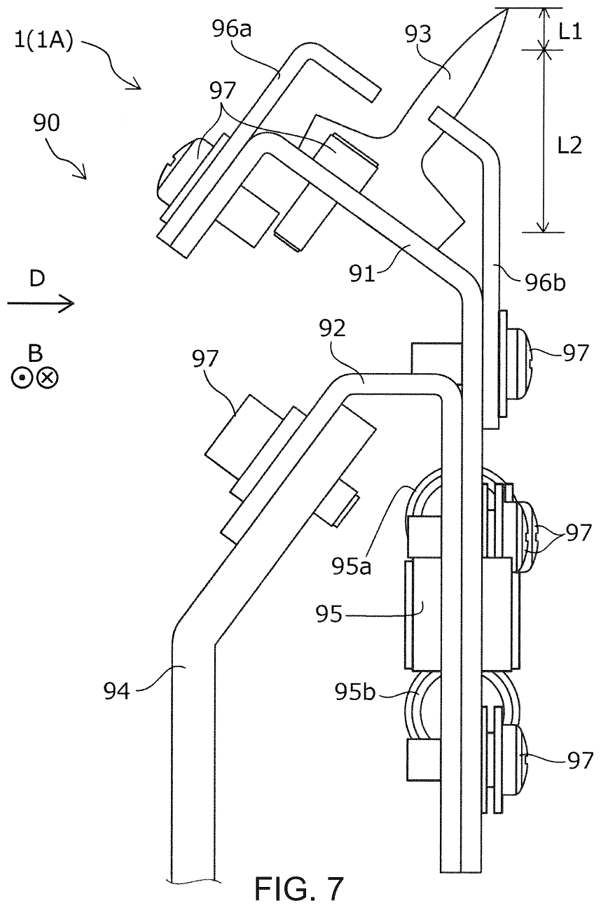

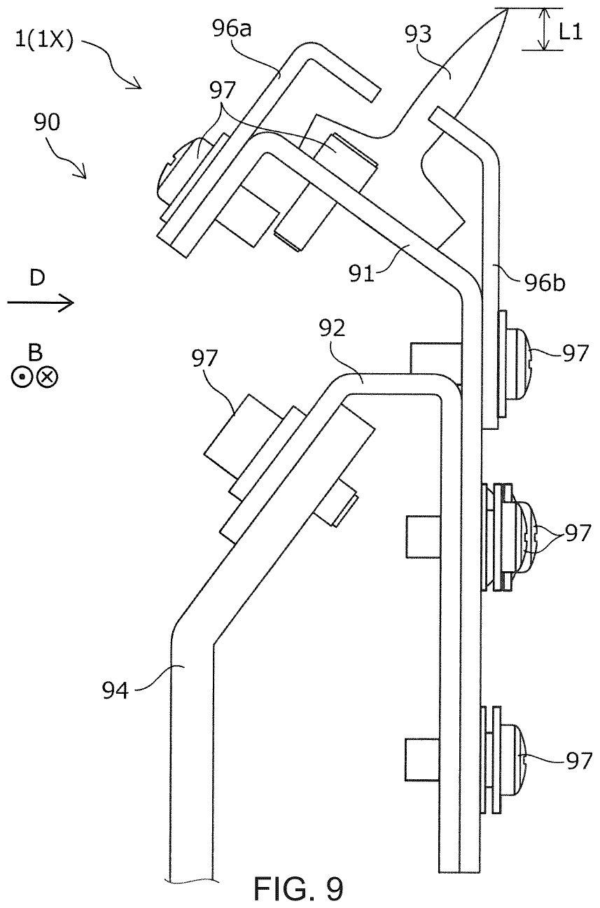

Here, it will be described in detail with reference to FIGS. 7 to 10 that the recording device 1A of the present embodiment includes a configuration in which the second frame 92 movably supports the first frame 91 along the normal direction of the outer peripheral surface 5a, and thus it is possible to particularly increase the degree of freedom between the transport belt 5 and the blade 93. In the recording device 1A of the present embodiment shown in FIG. 7, the blade 93 bends in contact with the outer peripheral surface 5a, whereby the distance between the blade 93 and the outer peripheral surface 5a can be adjusted to be reduced by a length L1, and the first frame 91 moves along the normal direction of the outer peripheral surface 5a with respect to the second frame 92, whereby the distance between the blade 93 and the outer peripheral surface 5a can be adjusted to be reduced by a length L2. On the other hand, in a recording device 1 of a reference example shown in FIG. 9, since the first frame 91 is fixed to the second frame 92, it is possible to adjust only the length L1 due to the blade 93 contacting the outer peripheral surface 5a and bending. In this adjustment, a position of a base of the blade 93 and a position of the outer peripheral surface 5a in the normal direction are adjusted with reference to a position where a tip end of the blade 93 is in contact with the outer peripheral surface 5a in a state where no biasing force is applied.

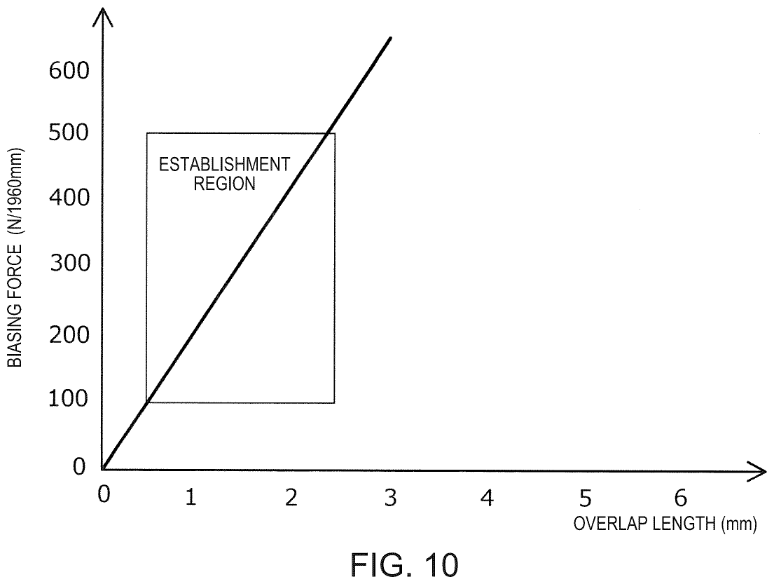

Therefore, in a recording device 1X of the reference example shown in FIG. 9, an overlap length can be limited to about 2.5 mm with respect to how close the blade 93 can be brought to a position of the outer peripheral surface 5a in the normal direction of the outer peripheral surface 5a, in other words, how long the overlap length with respect to the outer peripheral surface 5a can be. FIG. 10 shows the relationship between the overlap length and the biasing force applied to the outer peripheral surface 5a in the recording device 1X of the reference example shown in FIG. 9. In detail, it shows how much biasing force is applied to the outer peripheral surface 5a of 1960 mm width (length of the width direction B is 1960 mm) when changing the overlap length. Here, the overlap length indicates how long the tip end of the blade 93 enters in the normal direction with respect to a position of the outer peripheral surface 5a when the transport belt 5 was removed from the recording device 1.

In the recording device 1X of the reference example shown in FIG. 9, the overlap length change only due to the blade 93 contacting the outer peripheral surface 5a and bending. Therefore, as shown in FIG. 10, the relationship between the overlap length and the biasing force is a proportional relationship. If the overlap length becomes too short, the biasing force may become too small due to design tolerances or variations in constituent members. Therefore, the minimum biasing force is 100 N. In other words, by setting the biasing force to 100 N or more, the blade 93 can be suitably bent, and washing liquid clinging to the outer peripheral surface 5a can be effectively wiped off. However, if the biasing force becomes too large, the frictional force between the blade 93 and the outer peripheral surface 5a becomes large, which may cause a transport failure or the increase in power consumption due to the increase in transport load.

For this reason, in the recording device 1X of the reference example shown in FIG. 9, the biasing force in an establishment region is in a range of 100 N or more and 500 N or less. The establishment region is a region where there is overlap between an overlap range in which washing liquid clinging to the transport belt 5 is not left unwiped when the blade 93 contacts the outer peripheral surface 5a and a biasing force in which transport load caused by biasing of the blade 93 to the outer peripheral surface 5a does not exceed the upper limit value. Here, the overlap range is in the range of 0.5 mm to 2.5 mm, and the upper limit value of 2.5 mm is desirably a larger value. This is because, if the overlap range is narrow, the biasing force may be too small due to variations in design tolerances and constituent members, which may result in unwiped portions. It is desirable that the upper limit value of 500 N for the biasing force is a smaller value. This is because, if the biasing force is too large, a transport failure is caused and the increase in power consumption due to the increase in transport load is caused.

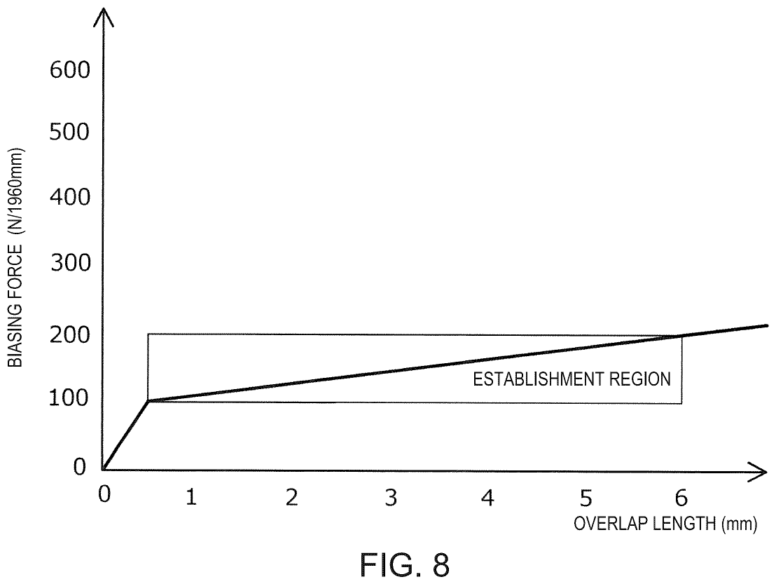

On the other hand, in the recording device 1A of the present embodiment shown in FIG. 7, in addition to the blade 93 contacting the outer peripheral surface 5a and bending, the first frame 91 moves along the normal direction of the outer peripheral surface 5a with respect to the second frame 92, and thus the overlap length changes. Therefore, as shown in FIG. 8, the relationship between the overlap length and the biasing force changes in two steps. Specifically, when the overlap range is up to 0.5 mm, the blade 93 contacts the outer peripheral surface 5a and bends, so that the overlap length changes, and when the overlap range is from 0.5 mm, the first frame 91 moves along the normal direction of the outer peripheral surface 5a with respect to the second frame 92, so that the overlap length changes.

Therefore, in the recording device 1A of the present embodiment shown in FIG. 7, the biasing force in the establishment region is set to be equal to or larger than 100 N and equal to or less than 200 N. As described above, even when the range of the biasing force is narrowed, the overlap range is increased from 0.5 mm to 6.0 mm. Therefore, the recording device 1A of the present embodiment can suppress the unwiped portion due to design tolerance, variation in the constituent members, or the like, and can suppress the occurrence of transport failure or the increase in power consumption due to the increase in transport load.

Here, in the recording device 1A of the present embodiment, as described above, the elastic member that biases the first frame 91 with respect to the second frame 92 is the spring 95. With such a configuration of the elastic member, a low-cost and simple configuration can be achieved.

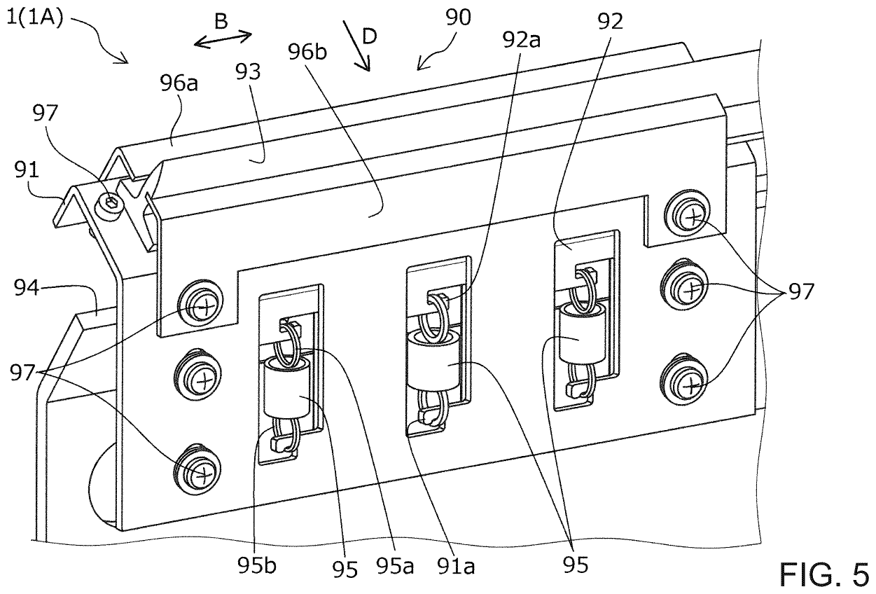

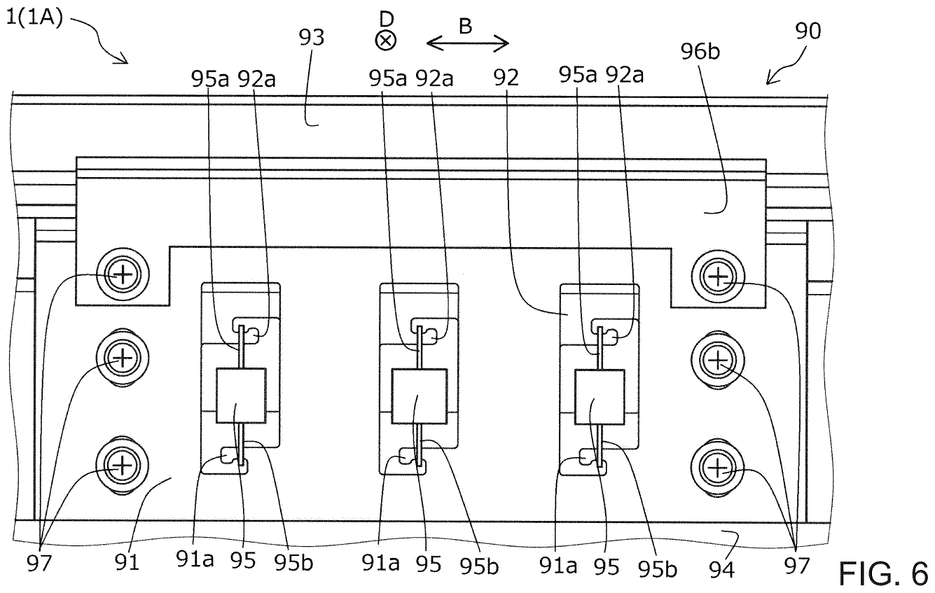

As shown in FIGS. 5 and 6, the spring 95 in the recording device 1A of the present embodiment includes an attaching section 95b, which can be attached to the attached section 91a of the first frame 91, and an attaching section 95a, which can be attached to the attached section 92a of the second frame 92. By configuring the elastic member in this way, it is possible to attach the elastic member to the first frame 91 and the second frame 92, and it is possible to easily configure the second frame 92 that movably supports the first frame 91 along the normal direction of the outer peripheral surface 5a. However, the elastic member is not limited to such a configuration. For example, the elastic member may be composed of a member other than the spring 95, for example, a rubber member.

On the other hand, by configuring the elastic member with the spring 95, an initial load can be set to an arbitrary value by a user. For example, an adhesive applied to the outer peripheral surface 5a of the transport belt 5 deteriorates and peels off as time passes. A user can maintain the performance of wiping off washing liquid by mounting the spring 95 with a larger initial load than the spring 95 mounted when the spring 95 is new, in accordance with degree of deterioration of the transport belt 5. Further, a user can arbitrarily select an adhesive and apply it to the outer peripheral surface 5a of the transport belt 5, and the appropriate biasing force on the outer peripheral surface 5a of the blade 93 varies depending on the type of adhesive used. As will be described later, in the recording device 1A of the present embodiment, the type and number of the spring 95 can be freely selected, so that the performance of wiping washing liquid can be maintained regardless of the type of adhesive.

Further, in the recording device 1A of the present embodiment, the attached section 91a and the attached section 92a are convex, while the attaching section 95a and the attaching section 95b are annular, and the spring 95 allows the first frame 91 to be easily attached to the second frame 92 and also enables easy attachment and detachment with respect to the first frame 91 and the second frame 92. For this reason, the recording device 1A of the present embodiment particularly has improved ease of assembly.

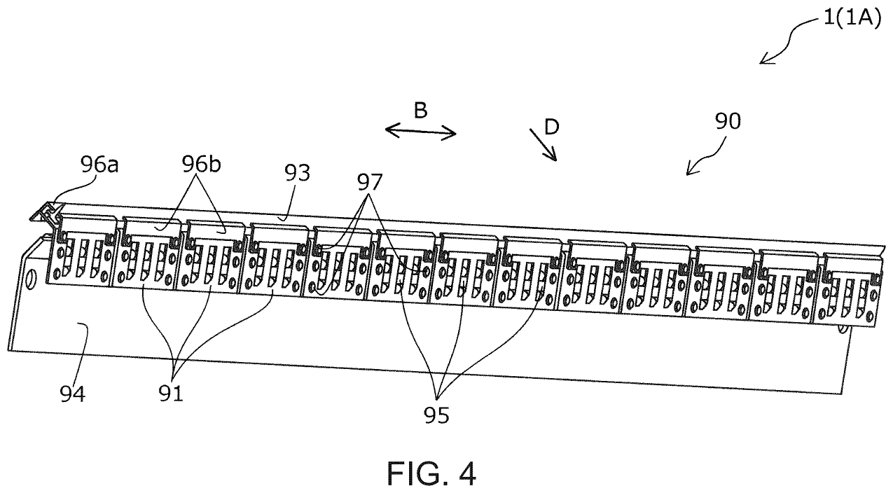

As shown in FIG. 4, the recording device 1A of the present embodiment includes a plurality of the first frames 91 arranged in the width direction B, and as shown in FIGS. 4, 5, and 6, in the recording device 1A of the present embodiment, a plurality of the springs 95, which are elastic members, can be attached to one first frame 91. Since the recording device 1A of the present embodiment includes such a configuration, for example, by changing the number or the type of the elastic member attached to one first frame 91, it is possible to bias the blade 93 to the outer peripheral surface 5a with a suitable biasing force. Specifically, the spring 95 can be replaced with a spring having a strong biasing force, some of the springs 95 can be left removed, or the like. Further, by replacing the spring 95 of the first frame 91 positioned at an end section in width direction B with a spring having a strong biasing force or replacing the spring 95 of the first frame 91 positioned at a central section in width direction B with a spring having a weak biasing force, a biasing force of the blade 93 against the outer peripheral surface 5a in width direction B can be changed.

As is clear from a comparison of FIGS. 2, 3, and 4, in the recording device 1A of the present embodiment, a plurality of first frames 91 are connected to one second frame 92 via springs 95. Since the recording device 1A of the present embodiment includes such a configuration, the second frame 92 easily supports each of the first frames 91 so as to be movable along the normal direction of the outer peripheral surface 5a, and it is possible to improve followability of the first frame 91 with respect to the outer peripheral surface 5a. Therefore, effect of the blade 93 wiping the outer peripheral surface 5a can be enhanced.

As shown in FIGS. 5, 6, and 7, the first frame 91 is fastened to the second frame 92 with a plurality of screws 97. Specifically, a screw shaft of a screw 97 fixed to the second frame 92 is inserted into a screw hole of the first frame 91, and the first frame 91 is sandwiched between the second frame 92 and a screw head of the screw 97. Here, the screw hole of the first frame 91 is an elongated hole that is elongated along the normal direction of the outer peripheral surface 5a, longer along the normal direction of the outer peripheral surface 5a as compared with the screw shaft of the screw 97. Therefore, the first frame 91 is movable along the normal direction of the outer peripheral surface 5a with respect to the second frame 92.

### Second Embodiment

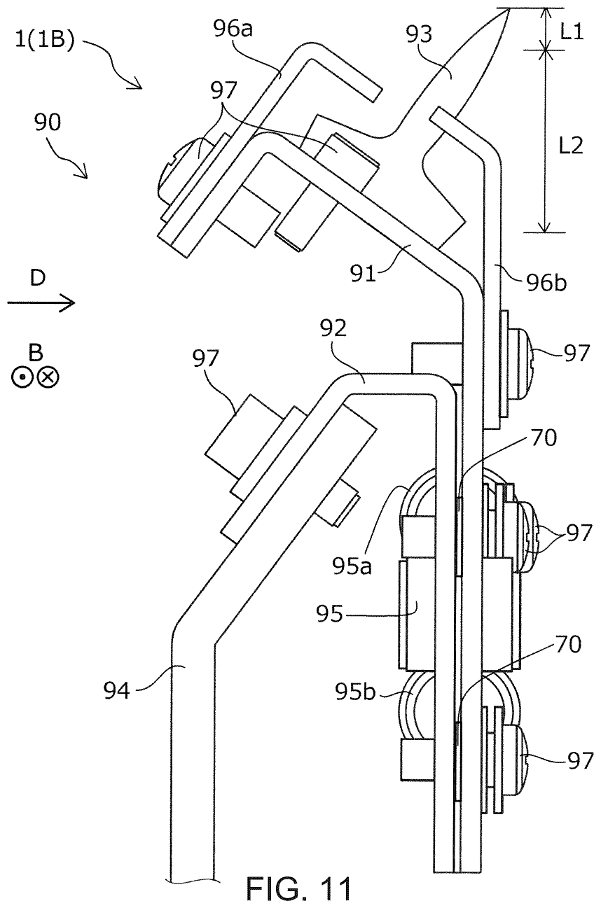

Next, a recording device 1B of a second embodiment will be described with reference to FIG. 11. Here, FIG. 11 is a view corresponding to FIG. 7 of the recording device 1A of the first embodiment. In FIG. 11, constituent members common to those of the first embodiment are denoted by the same reference symbols, and a detailed description thereof will be omitted. Here, the recording device 1B of the present embodiment includes the same configuration as the recording device 1A of the first embodiment except for the configuration of the blade forming section 90. For this reason, the recording device 1B of the present embodiment has the same features as those of the recording device 1A of the first embodiment except for the parts described below.

As shown in FIG. 11, the recording device 1B of the present includes a plastic washer 70, which is a sliding member, between the first frame 91 and the second frame 92. For this reason, in the recording device 1B of the present embodiment, the first frame 91 easily moves with respect to the second frame 92. The sliding member is not particularly limited as long as the first frame 91 is easily moved with respect to the second frame 92 toward the case where there is a sliding member as compared with the case where there is no sliding member, in addition to a washer made of plastic as in the present embodiment, it may be a fluid such as grease.

The present disclosure is not limited to the above-described embodiments, and various modifications can be made within the scope of the disclosure described in the claims, and it goes without saying that they are also included in the scope of the present disclosure.

What is claimed is:

1. A transport device comprising:
a transport belt that includes an outer peripheral surface for supporting a medium and that is configured to transport the medium;
a blade configured to wipe the outer peripheral surface by contacting the outer peripheral surface;
a first frame that holds the blade;
an elastic member configured to bias the first frame in a direction in which the blade contacts the outer peripheral surface; and
a second frame that supports the first frame so that the first frame is movable along a normal direction of the outer peripheral surface.

2. The transport device according to claim 1, wherein the elastic member is a spring.

3. The transport device according to claim 2, wherein
the spring includes an attaching section configured to be attached to the first frame and the second frame.

4. The transport device according to claim 1, wherein
the elastic member is attached to the first frame and the second frame and is configured to be attached to and detached from the first frame and the second frame.

5. The transport device according to claim 4, wherein
the first frame is configured to attach a plurality of the elastic members.

6. The transport device according to claim 5, wherein
a plurality of the first frames are connected to one second frame via the elastic member.

7. The transport device according to claim 1, further comprising:
a sliding member positioned between the first frame and the second frame.

8. A recording device comprising:
the transport device according to claim 1 and
a recording section configured to perform recording on the medium transported by the transport belt.
